(19) United States
(12) Patent Application Publication
(10) Pub. No.: US 2015/0260376 A1
(43) Pub. Date: Sep. 17, 2015

(54) LIGHT EMITTING DIODE MODULE LENS AND LIGHT EMITTING DIODE MODULE LIGHTING APPARATUS

(71) Applicant: SAMSUNG ELECTRONICS CO., LTD., Suwon-si (KR)

(72) Inventor: Seong-ah JOO, Pyeongtaek-si (KR)

(73) Assignee: SAMSUNG ELECTRONICS CO., LTD., Suwon-si (KR)

(21) Appl. No.: 14/588,552

(22) Filed: Jan. 2, 2015

(30) Foreign Application Priority Data
Mar. 11, 2014 (KR) 10-2014-0028592

(51) Int. Cl. F21V 17/10; F21V 5/00; F21V 17/12; F21K 99/00; F21V 17/02; F21V 29/70

(52) U.S. Cl. CPC F21V 17/107; F21V 17/02; F21V 29/70; F21V 17/12; F21K 9/50; F21V 5/007; F21Y 2101/02

(57) ABSTRACT

Provided are a lens plate for a lighting emitting diode (LED) module, and the LED module. The lens plate includes: a lens substrate having a plane structure; at least one lens having a dome structure formed on the lens substrate; and a hinge structure on a side of the lens substrate and including a fastener configured to fasten to the LED module.

### CROSS-REFERENCE TO RELATED APPLICATION

This application claims priority from Korean Patent Application No. 10-2014-0028592, filed on Mar. 11, 2014 in the Korean Intellectual Property Office, the disclosure of which is incorporated herein in its entirety by reference.

### BACKGROUND

Apparatuses and methods consistent with exemplary embodiments relate to a light emitting diode (LED) module lens and an LED module lighting apparatus, and more particularly, to a lens plate mounted in an LED module and an LED module lighting apparatus including the lens plate.

As efficiency and brightness of light emitting devices, such as LEDs, have rapidly increased, attempts to replace various related art light sources have actively been made. To this end, a high brightness and high power LED having a greater size and higher input power than those of related art devices has been developed and commercialized.

A lens plate for concentrating and distributing light needs to be mounted in a lighting apparatus that uses an LED module in which a plurality of LEDs are collected.

### SUMMARY

The inventive concept provides a light emitting diode (LED) module lens that reduces a time and effort taken to use a lens fastening method of directly inserting a screw into a lens plate to solve a problem of inefficient processing and simultaneously enables strong fastening and detachment when mounting the lens plate in an LED module, and an LED module lighting apparatus in which the LED module lens is mounted.

According to an aspect of an exemplary embodiment, there is provided a lens plate for a light emitting diode (LED) module, the lens plate including: a lens substrate having a plane structure; at least one lens having a dome structure on the lens substrate; and a hinge structure on a side of the lens substrate and including a fastener configured to fasten with the LED module.

The hinge structure may be integrally formed with the lens substrate.

The hinge structure may include an elastic material and may be foldable with respect to the lens substrate.

The fastener may be a fastening hole having a straight line shape in a direction parallel to a top surface of the lens substrate.

The fastener may be a fastening protrusion that protrudes from an inner surface of the hinge structure.

The lens plate may include a plurality of hinge structures, including the hinge structure, on two opposite sides of the lens substrate.

According to an aspect of another exemplary embodiment, there is provided an LED module lighting apparatus including: a heat dissipation member configured to dissipate heat; a substrate on a top surface of the heat dissipation member; at least one LED device mounted on the substrate; and a lens plate for an LED module, the lens plate configured to cover the heat dissipation member, the substrate, and a top surface of the at least one LED device, wherein the lens plate includes a hinge structure on a side of the lens plate, the hinge structure including a first fastener configured to fasten with the heat dissipation member, wherein the heat dissipation member includes a second fastener on a side surface of the heat dissipation member, and wherein the first fastener and the second fastener are coupled to each other so that the heat dissipation member and the lens plate for the LED module are connected.

The LED module lighting apparatus may further include: a sealant between the top surface of the heat dissipation member and a bottom surface of the lens plate.

The sealant may be along each side edge of the top surface of the heat dissipation member.

The second fastener may protrude to an outside of the heat dissipation member, the first fastener may be a fastening hole having a size corresponding to that of the second fastener, and wherein the hinge structure may be connected to the second fastener through the fastening hole.

The second fastener may be a fastening groove having a predetermined size, the hinge structure may further include a hinge body, the first fastener may be a fastening protrusion protruding in a perpendicular direction with respect to an inner side surface of the hinge body, the fastening protrusion may have a same size as that of the fastening groove, and the fastening protrusion may be inserted into the fastening groove so that the hinge structure is coupled to the heat dissipation member.

The lens plate may further include a plurality of hinge structures, including the hinge structure, on two opposite sides of the lens plate, the heat dissipation member may further include a third fastener, the second fastener and the third fastener may be on opposite sides of the heat dissipation member corresponding to the two opposite sides in which the hinge structures are, and wherein the plurality of hinge structures and the second and third fasteners are coupled to each other.

The hinge structure may be elastic so that the hinge structure is unfoldable to be parallel to a top surface of the lens plate of the LED module, and foldable in a direction toward the heat dissipation member.

The first fastener may be separable from the second fastener after being coupled thereto, and the lens plate may be detachable from the heat dissipation member when the first fastener is separated from the second fastener.

The first fastener may be at least one lens plate screw hole formed in the hinge structure, the second fastener may be at least one heat dissipation member screw hole formed in the heat dissipation member and corresponding to the at least one lens plate screw hole, at least one fastening screw may be inserted into the at least one lens plate screw hole, and the at least one fastening screw may be fastened to the at least one heat dissipation member screw hole so that the lens plate and the heat dissipation member are coupled to each other.

According to an aspect of another exemplary embodiment, there is provided an LED module lighting apparatus including: an LED module including at least one LED device; and a lens plate configured to cover the at least one LED device, wherein the lens plate includes: a lens substrate having a plane structure, at least one lens on the lens substrate, and a hinge structure on a side of the lens substrate and including a fastener configured to fasten with the LED module.

The hinge structure may be integrally formed with the lens substrate and may be foldable with respect to the lens substrate.

The fastener may be a fastening hole having a straight line shape in a direction parallel to a top surface of the lens substrate.

The fastener may be a fastening protrusion that protrudes from an inner surface of the hinge structure.

The fastener may be at least one lens plate screw hole formed in the hinge structure.

### BRIEF DESCRIPTION OF THE DRAWINGS

Exemplary embodiments will be more clearly understood from the following detailed description taken in conjunction with the accompanying drawings in which:

FIGS. 1 through 3 are perspective views of light emitting diode (LED) module lens plates according to exemplary embodiments;

FIGS. 4A through 4C are plan views of LED module lens plates according to exemplary embodiments;

FIG. 5 is a perspective view of an LED module lens plate and an LED module according to an exemplary embodiment;

FIG. 6 is a perspective view of an LED module lighting apparatus according to an exemplary embodiment;

FIG. 7 is a cross-sectional view of a line A-A′ of the LED module lighting apparatus of FIG. 6;

FIG. 8 is a perspective view of an LED module lighting apparatus according to another exemplary embodiment;

FIG. 9 is a cross-sectional view of a line B-B′ of the LED module lighting apparatus of FIG. 8;

FIG. 10 is a perspective view of an LED module lighting apparatus according to another exemplary embodiment;

FIG. 11 is a cross-sectional view of the LED module lighting apparatus of FIG. 10;

FIG. 12 is a conceptual diagram of an LED module lighting apparatus system according to an exemplary embodiment;

FIG. 13 is a conceptual diagram of an LED module lighting apparatus system according to another exemplary embodiment; and

FIG. 14 is a diagram of an example of an LED device applied to a head lamp according to an exemplary embodiment.

### DETAILED DESCRIPTION OF EXEMPLARY EMBODIMENTS

Hereinafter, exemplary embodiments will be described more fully with reference to the accompanying drawings, in which exemplary embodiments are shown. Exemplary embodiments may, however, be embodied in many different forms and should not be construed as limited to exemplary embodiments set forth herein. Rather, these exemplary embodiments are provided so that this disclosure will be thorough and complete, and will fully convey the scope of the inventive concept to one of ordinary skill in the art. Sizes of components in the drawings may be exaggerated for convenience of explanation.

It will be understood that when an element is referred to as being “on” or “contact” another element, it may be directly connected or contact the other element or intervening elements may be present. In contrast, when an element is referred to as being “directly on” or “directly contact” another element or layer, there are no intervening elements present. Other expressions for describing relationships between elements, for example, “between” and “immediately between”, may also be understood likewise.

Spatially relative terms, such as “below” or “lower” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures.

It will also be understood that, although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of the present inventive concept.

The terminology used herein is for the purpose of describing particular exemplary embodiments only and is not intended to be limiting of exemplary embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Furthermore, expressions such as “at least one of,” when preceding a list of elements, modify the entire list of elements and do not modify the individual elements of the list.

Unless otherwise defined, all terms used herein have the same meaning as commonly understood by one of ordinary skill in the art to which exemplary embodiments belong.

Hereinafter, exemplary embodiments will be described with reference to the accompanying drawings.

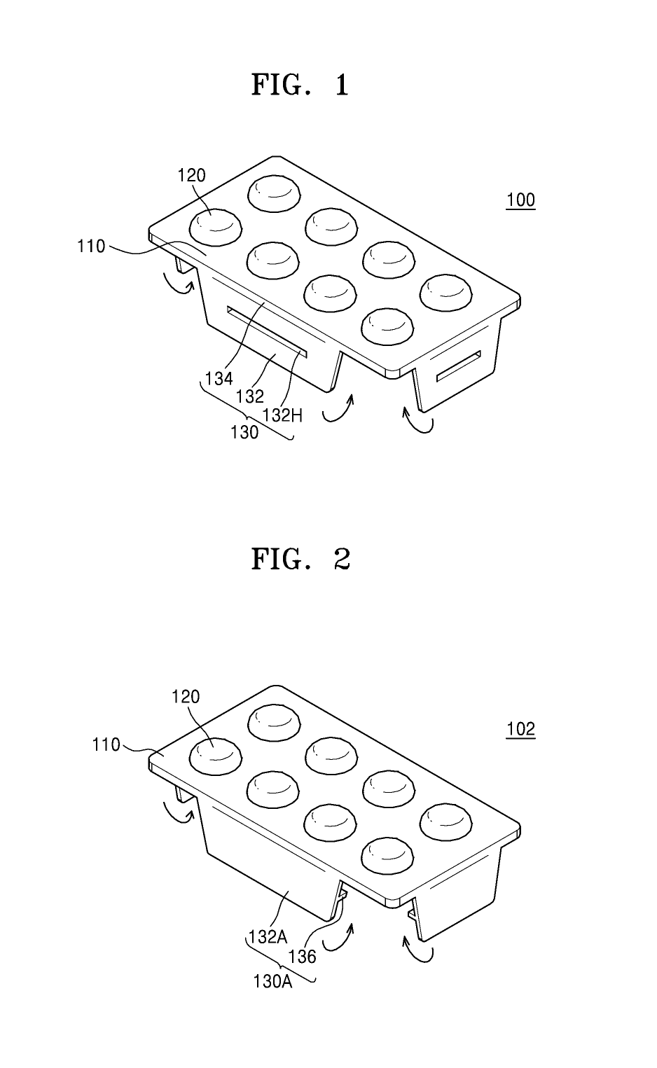

FIG. 1 is a perspective view of a light emitting diode (LED) module lens plate 100 according to an exemplary embodiment.

Referring to FIG. 1, the LED module lens plate 100 includes a lens substrate 110, at least one lens unit 120 (e.g., lens structure, lens, etc.) formed (e.g., provided) on a top surface of the lens substrate 110, and a hinge structure 130 formed on each side of the lens substrate 110.

In the present exemplary embodiment, the lens substrate 110 has a plane structure having a rectangular shape, although it is understood that one or more other exemplary embodiments are not limited thereto. For example, according to another exemplary embodiment, the lens substrate 110 may have a polygonal plane structure or a circular plane structure. The lens substrate 110 may be formed of (e.g., include) resin having excellent light transparency. For example, the lens substrate 110 may be formed of at least one selected from the group consisting of epoxy resin, silicon resin, acrylic resin, and polycarbonate. According to the present exemplary embodiment, the lens substrate 110 may be formed of polycarbonate.

At least one lens unit 120 is formed on the top surface of the lens substrate 110. The at least one lens unit 120 is configured to reflect, concentrate, and/or distribute light generated in at least one LED, and may be formed of resin of a transparent material having a refractive index of light that is greater than 1. For example, the at least one lens unit 120 may be formed of at least one selected from the group consisting of epoxy resin, acrylic resin, polycarbonate, and polymethylmethacrylate (PMMA). According to the present exemplary embodiment, the at least one lens unit 120 may be formed of polycarbonate. The at least one lens unit 120 may be formed using various molding methods such as transfer molding or injection molding according to manufacturing methods. Although the at least one lens unit 120 is formed in a top bulging dome shape according to the present exemplary embodiment, it is understood that one or more other exemplary embodiments are not limited thereto, and the at least one lens unit 120 may have various shapes. The number of lens units 120 is eight in FIGS. 1 through 3, although it is understood that one or more other exemplary embodiments are not limited thereto. That is, according to another exemplary embodiment, the number of lens units 120 may be less than 8 or greater than or equal to 9.

The hinge structure 130 may be formed on each of four sides of the lens substrate 110. The hinge structure 130 includes a hinge body 132, a connection unit 134 (e.g., connector) formed between the hinge body 132 and each side of the lens substrate 110, and a fastening hole 132H formed in the hinge body 132. The hinge structure 130 may be integrally formed with the lens substrate 110.

The hinge body 132 may be formed of transparent or semitransparent resin. The hinge body 132 may not be related to a function of reflecting, concentrating, or distributing light from the LED, and thus the hinge body 132 may not be transparent. The hinge body 132 may be formed of at least one selected from the group consisting of epoxy resin, silicon resin, acrylic resin, and polycarbonate. According to the present exemplary embodiment, the hinge body 132 may be integrally formed with the lens substrate 110 so that the hinge body 132 may be, for example, formed of polycarbonate.

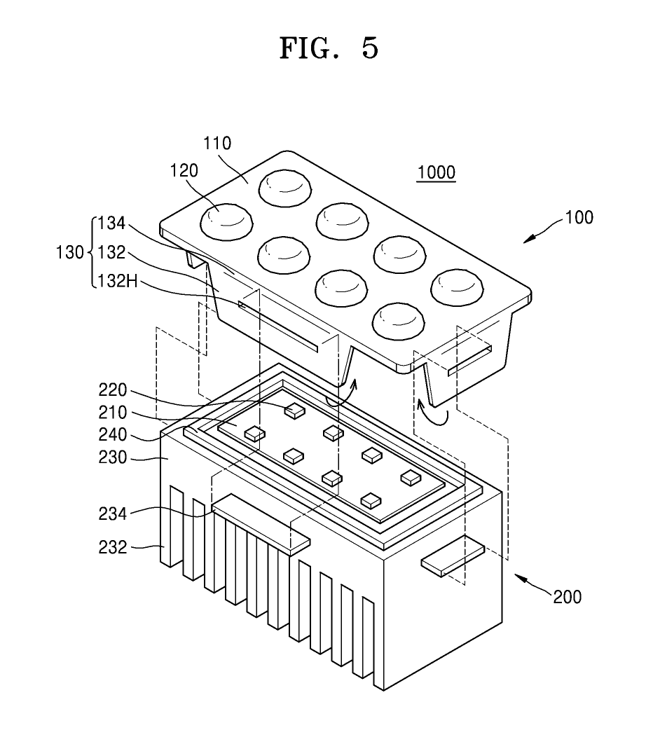

The connection unit 134 is formed between the hinge body 132 and each side of the lens substrate 110. The hinge body 132 may be connected to the lens substrate 110 via the connection unit 134. The connection unit 134 may be formed of elastic resin. According to the present exemplary embodiment, the connection unit 134 may be thin compared to the hinge body 132, and may be elastic so as to be foldable. The connection unit 134 folds so that the hinge body 132 may be folded in a direction of an arrow of FIG. 1. In particular, the connection unit 134 has a folding structure so that the hinge body 132 may be unfolded in a direction parallel to a top surface of the lens substrate 110 and may be folded in a direction perpendicular to the top surface of the lens substrate 110. As will be described below with reference to FIG. 5, the hinge body 132 may be connected to an LED module 200 (see FIG. 5) when folded in the direction of the arrow, i.e., folded in the direction perpendicular to the top surface of the lens substrate 110.

The fastening hole 132H having a predetermined width and height in a straight line shape is formed in the hinge body 132 in the direction parallel to the top surface of the lens substrate 110. The fastening hole 132H is fastened to a fastening protrusion unit 234 (e.g., fastening protrusion) (see FIG. 5) formed in a heat dissipation member of the LED module 200 (see FIG. 5), of which a detailed description will be provided below with reference to FIG. 5.

The lens substrate 110, the lens unit 120, and the hinge body 130 may be integrally formed. The lens substrate 110, the lens unit 120, and the hinge body 130 may be simultaneously formed by using a manufacturing method such as injection molding or transfer molding. In this case, the lens substrate 110, the lens unit 120, and the hinge body 130 may be formed of a same material.

FIG. 2 is a perspective view of an LED module lens plate 102 according to another exemplary embodiment.

Referring to FIG. 2, the LED module lens plate 102 includes the lens substrate 110, the at least one lens unit 120, and a hinge structure 130A, similar to the LED module lens plate 100 of FIG. 1. However, a structure of the hinge structure 130A in the present exemplary embodiment is different from that of the hinge structure 130 of FIG. 1. Redundant descriptions of the lens substrate 110 and the lens unit 120 will not be repeated below.

The hinge structure 130A includes a hinge body 132A and a fastening protrusion unit 136 (e.g., fastening protrusion). The LED module lens plate 102 according to the present exemplary embodiment does not include the fastening hole 132H (see FIG. 1) included in the LED module lens plate 100 of FIG. 1. The hinge body 132A may have the same basic shape as that of the hinge body 132 of FIG. 1 and may be formed of the same material as that of the hinge body 132 of FIG. 1.

The fastening protrusion unit 136 that protrudes from an inner surface of the hinge body 132A is formed on the hinge body 132A. The fastening protrusion unit 136 may be integrally provided with the hinge body 132A. The fastening protrusion unit 136 may protrude outward in a direction perpendicular to the inner surface of the hinge body 132A. The fastening protrusion unit 136 protrudes from a center part of the inner surface of the hinge body 132a in FIG. 1, although it is understood that one or more other exemplary embodiments are not limited thereto. For example, the fastening protrusion unit 136 may protrude from an edge of the inner surface of the hinge body 132A, or closer to one end of the hinge body 132A than an opposite end of the hinge body 132A. A shape of the fastening protrusion unit 136 may be formed in various ways, for example, in an L shaped protrusion unit, in a hook shape, etc.

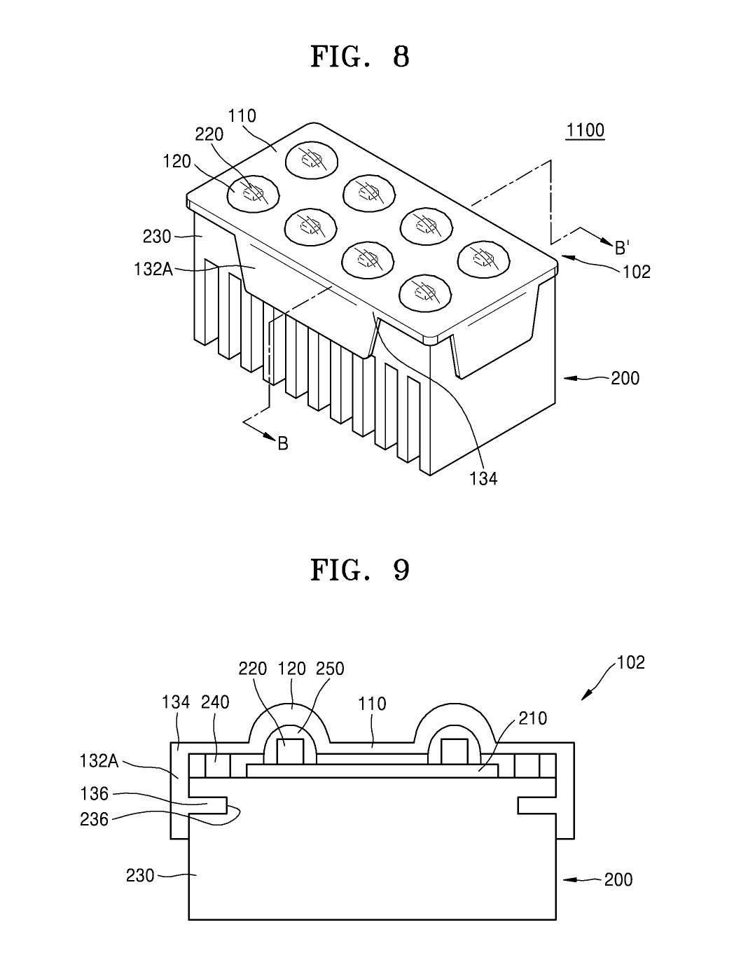

The fastening protrusion unit 136 is inserted into and fastened to an opening (e.g., a fastening groove 236) formed in a heat dissipation member 230 (see FIGS. 8 and 9) of an LED module (see FIGS. 8 and 9), of which a detailed description will be provided below with reference to FIGS. 8 and 9.

In the LED module lens plate 102 according to the present exemplary embodiment, like the LED module lens plate 100 of FIG. 1, the lens substrate 110, the lens unit 120, and the hinge structure 130A may be integrally formed. A method of manufacturing the lens substrate 110, the lens unit 120, and the hinge structure 130A is the same as or similar to that described above with reference to FIG. 1, and thus redundant descriptions thereof will not be repeated below.

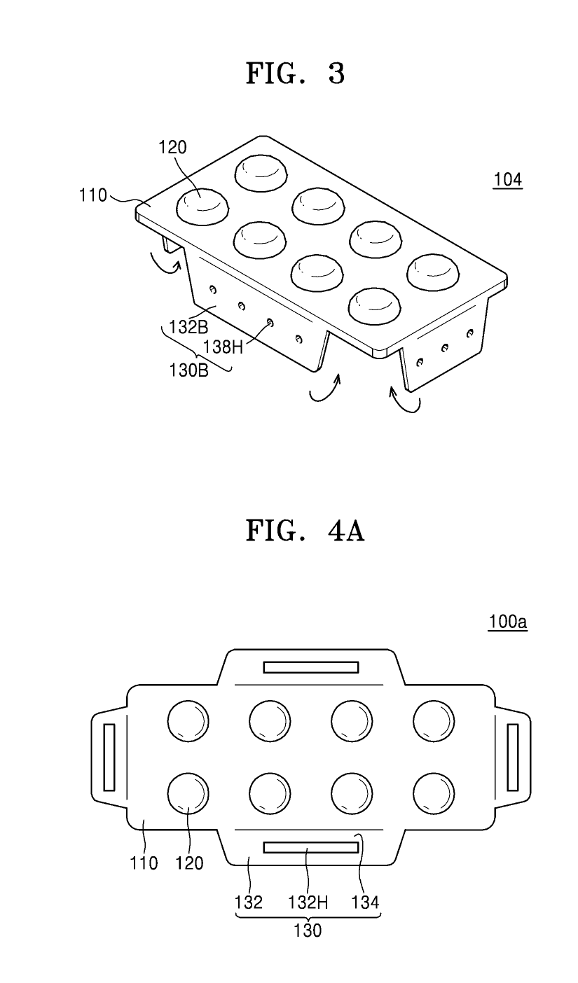

FIG. 3 is a perspective view of an LED module lens plate 104 according to another exemplary embodiment.

Referring to FIG. 3, the LED module lens plate 104 includes the lens substrate 110, the at least one lens unit 120, and a hinge structure 130B, similar to the LED module lens plate 100 of FIG. 1. However, a structure of the hinge structure 130B in the present exemplary embodiment is different from that of the hinge structure 130 of FIG. 1. Redundant descriptions of the lens substrate 110 and the lens unit 120 are not repeated below.

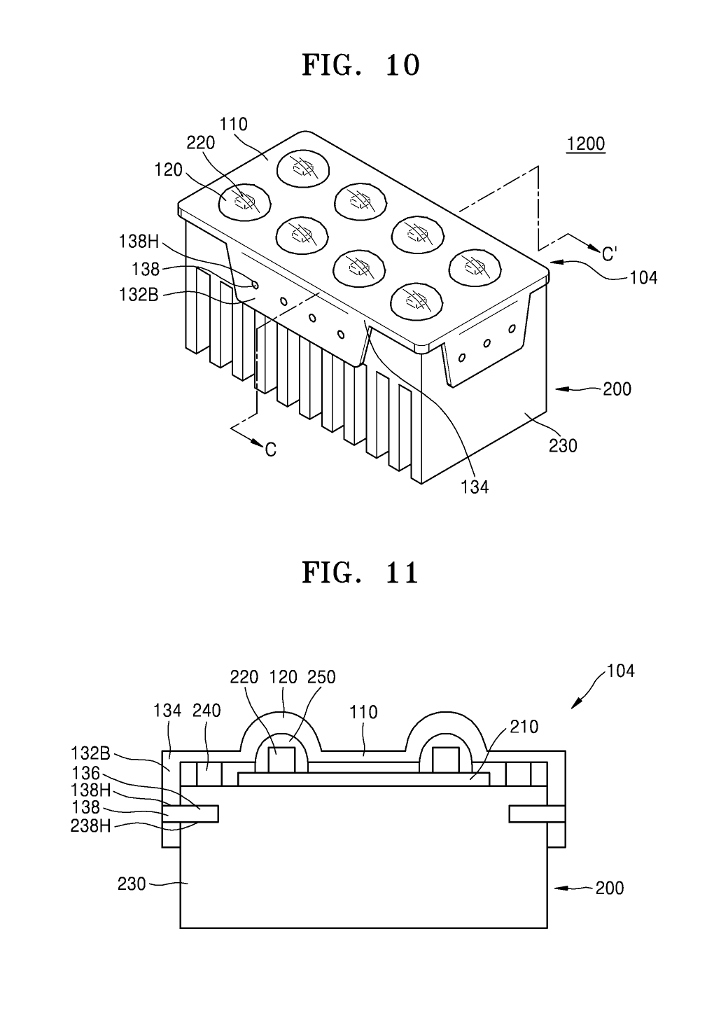

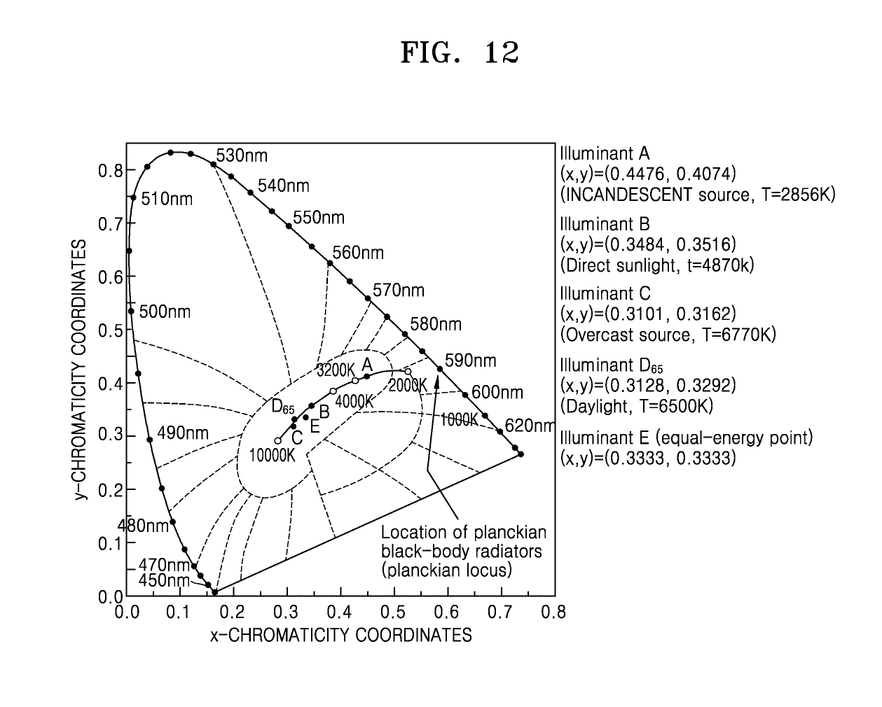

The hinge structure 130B includes a hinge body 132B and a fastening screw hole 138H. The fastening screw hole 138H is formed in the hinge body 132B. The fastening screw hole 138H may be formed as one fastening screw hole or two or more fastening screw holes in the hinge body 132B. Although the number of the fastening screw holes 138H is four in FIG. 3, it is understood that one or more other exemplary embodiments are not limited thereto. Furthermore, the fastening screw hole 138H may be formed as a circular hole, although it is understood that one or more other exemplary embodiments are not limited thereto. The fastening screw hole 138H is an opening into which a fastener (e.g., a fastening screw 138 (see FIGS. 10 and 11)) is inserted so that a heat dissipation member 230 (see FIGS. 10 and 11) and the LED module lens plate 104 may be coupled to each other. A detailed description of a coupling structure will be provided below with reference to FIGS. 10 and 11.

In the LED module lens plate 104 according to the present exemplary embodiment, like the LED module lens plate 100 of FIG. 1, the lens substrate 110, the lens unit 120, and the hinge structure 130B may be integrally formed. A method of manufacturing the lens substrate 110, the lens unit 120, and the hinge structure 130B is the same as or similar to that described above with reference to FIG. 1, and thus redundant descriptions thereof are not repeated below.

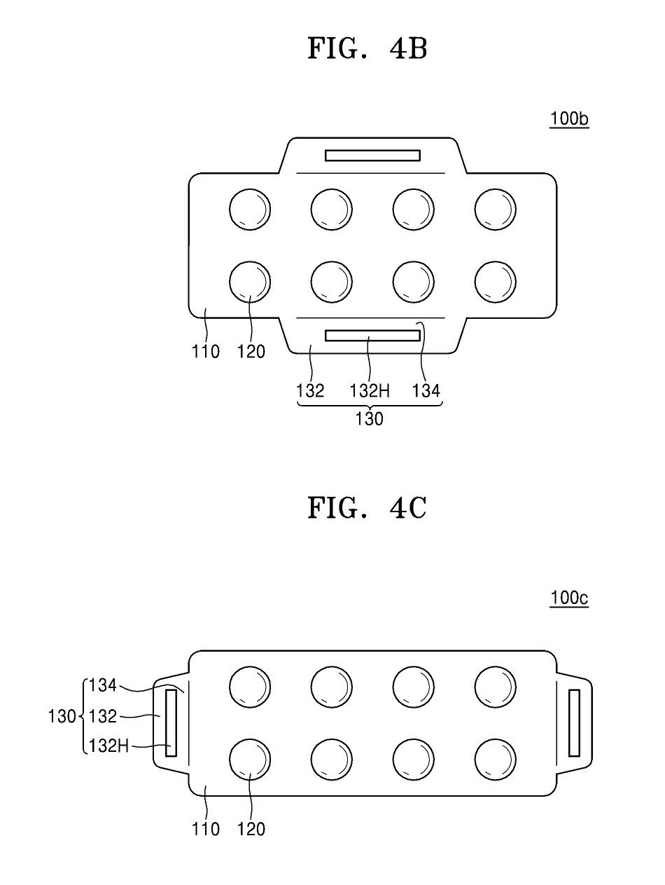

FIGS. 4A through 4C are plan views of LED module lens plates 100a through 100c according to exemplary embodiments.

Referring to FIG. 4A, the LED module lens plate 100a according to an exemplary embodiment includes the lens substrate 110, the circular lens unit 120 formed on the lens substrate 110, and the hinge structure 130 formed on each of sides of the lens substrate 110. The hinge structure 130 may be formed in a direction parallel to a top surface of the lens substrate 110. That is, the hinge structure 130, when unfolded, is parallel to the lens substrate 110 (see FIG. 1 and the description thereof).

Referring to FIG. 4B, the LED module lens plate 100b according to another exemplary embodiment is similar to the LED module lens plate 100a of FIG. 4A, although the hinge structures 130 are formed on two sides of the lens substrate 110. In more detail, the lens substrate 110 is formed to have a rectangular plane structure, wherein the hinge structures 130 are formed on both longer sides of the rectangular shape, although it is understood that one or more other exemplary embodiments are not limited thereto. For example, according to another exemplary embodiment, the hinge structures 130 may be provided on the shorter sides of the rectangular shape (as will be described below with reference to FIG. 4C). Additionally, according to another exemplary embodiment, the lens substrate 100 may be formed in another shape (e.g., a polygonal shape, a square shape, etc.).

Referring to FIG. 4C, the LED module lens plate 100c according to another exemplary embodiment is similar to the LED module lens plate 100a of FIG. 4A, although the hinge structures 130 are formed on two sides of the lens substrate 110. The hinge structures 130 are formed on both shorter sides of the rectangular shape of the lens substrate 110, unlike the exemplary embodiment illustrated in FIG. 4B.

In the LED module lens plates 100b and 100c of FIGS. 4B and 4C, the hinge structures 130 are formed on two sides of the lens substrate 110 rather than four sides thereof. In this regard, the hinge structures 130 on the two sides are configured to couple the LED module lens plates 100b and 100c to a heat dissipation member, as will be described below. Furthermore, while the hinge structures 130 illustrated in FIGS. 4A through 4C are provided with an opening (e.g., a fastening hole), it is understood that one or more other exemplary embodiments are not limited thereto. For example, according to another exemplary embodiment, each of the hinge structures 130 may include a protrusion (e.g., fastening protrusion), a hole (e.g., a fastening screw hole), a plurality of openings, a plurality of holes, etc.

FIG. 5 is a perspective view of an LED module lighting apparatus 1000 including an LED module lens plate 100 and an LED module 200 according to an exemplary embodiment. The LED module lens plate 100 is described with reference to FIG. 1, and thus a redundant description thereof is omitted below.

Referring to FIG. 5, the LED module 200 includes a heat dissipation member 230 (e.g., heat dissipater), a substrate 210 formed (e.g., provided) on a top surface of the heat dissipation member 230, at least one LED device 220 mounted on the substrate 210, and a sealant 240 (e.g., waterproof sealant) formed on the top surface of the heat dissipation member 230.

The heat dissipation member 230 according to the present exemplary embodiment has a rectangular shape (although it is understood that one or more other exemplary embodiments are not limited thereto), and includes a plurality of heat dissipation fins 232 in which thin rectangular planes extend in parallel to each other in lower portions of the heat dissipation member 230 (i.e., away from the LED module lens plate 100. The heat dissipation member 230 may be formed of (e.g., include) metal having a high thermal conductivity such that heat generated by the substrate 210 and the at least one LED device 220 may be easily dissipated to the outside. For example, the heat dissipation member 230 may be formed of at least one of copper (Cu), aluminum (Al), and an alloy of Cu and Al. The heat dissipation fins 232 are configured to have a plurality of thin planes standing in parallel to each other, which increases a contact surface with the outside, and thus heat may be easily dissipated. The heat dissipation fins 232 may be formed of the same material as that of the heat dissipation member 230 and may be integrally formed with the heat dissipation member 230.

A fastening protrusion unit 234 (e.g., fastening protrusion) is formed on a side surface of the heat dissipation member 230. According to the present exemplary embodiment, the fastening protrusion unit 234 is formed on the heat dissipation member 230, although it is understood that one or more other exemplary embodiments are not limited thereto. For example, according to another exemplary embodiment, the fastening protrusion unit 234 may be formed on the substrate 210 or on a separate frame. The fastening protrusion unit 234 according to the present exemplary embodiment is formed in a straight line in a direction parallel to the top surface of the heat dissipation member 230 and protrudes in a direction perpendicular to the side surface of the heat dissipation member 230, although it is understood that one or more other exemplary embodiments are not limited thereto. For example, according to another exemplary embodiment, the fastening protrusion unit 234 may be curved, jagged, etc., and/or may extend at an angle other than 90 degrees from a side surface. In the present exemplary embodiment, the fastening protrusion unit 234 has a same size or similar size as that of the fastening hole 132H of the LED module lens plate 100 and is fastened into the fastening hole 132H.

The substrate 210 and the at least one LED device 220 mounted on the substrate 210 are formed in a center portion of the top surface of the heat dissipation member 230, although it is understood that one or more other exemplary embodiments are not limited to this exact location. According to one or more exemplary embodiments, a heat transfer material layer (e.g., thermal grease) may be disposed between the top surface of the heat dissipation member 230 (i.e., a surface that faces the substrate 210) and a bottom surface of the substrate 210 (i.e., a surface that faces the heat dissipation member 230). The heat transfer material layer increases heat conductivity of a contact surface between the substrate 210 and the heat dissipation member 230, thereby improving a heat dissipation effect of the heat dissipation member 230.

The substrate 210 may be a printed circuit board (PCB) or a metal core PCB (MCPCB) coated with an insulating material such as resin on a surface of a metal plate. According to the present exemplary embodiment, the substrate 210 may be the MCPCB formed by coating an insulating material such as epoxy resin, polyethylene, polyimide, polyester, etc., on a surface of a metal plate such as aluminum, copper, steel, nickel, stainless steel, etc. According to one or more exemplary embodiments, a growth surface of the substrate 210 may have an unevenness for improvement of light extraction efficiency and for crystal growth of high quality.

The at least one LED device 220 is mounted on the substrate 210. The at least one LED device 220 may be one LED device or a plurality of LED devices. The number of the at least one LED device 220 is eight in FIG. 5, although it is understood that one or more other exemplary embodiments are not limited thereto. That is, the number of the at least one LED device 220 may vary according to, for example, use and necessity of an LED module lighting apparatus.

According to an exemplary embodiment, each of the at least one LED device 220 may include a light emitting stack structure including a first conductive semiconductor layer, a second conductive semiconductor layer, and an active layer disposed between the first conductive semiconductor layer and the second conductive semiconductor layer, and one or more contact holes that are electrically insulated from the second conductive semiconductor layer and the active layer to electrically connect to the first conductive semiconductor layer and extend from one surface of a first electrode layer to at least a partial region of the first conductive semiconductor layer. A second electrode layer may be formed (e.g., provided) including a conductive via formed by charging a conductive material in the contact holes.

The number of the contact holes, shapes, pitches, contact areas with the first and second conductive semiconductor layers, etc., may vary and may be appropriately adjusted such that a contact resistance of the contact holes may be lowered. The contact holes may be arranged in various shapes according to rows and columns, and thus a current flow may be improved. In this case, conductive vias may be surrounded by an insulating unit and may be electrically separated from the active layer and the second conductive semiconductor layer.

The number of vias including the rows and the columns and a contact area thereof may be adjusted such that an area of the vias that occupies a plane of a region contacting the first conductive semiconductor layer is within a range of from about 1% to about 5% of a plane area of the light emitting stack structure. Radii of the vias may be, for example, within a range of from about 5 μm to about 50 μm. The number of vias may be within a range of from 1 to about 50 per an area of the light emitting stack structure according to a width of the area of the light emitting stack structure. The number of the conductive vias may vary according to the width of the area of the light emitting stack structure. A distance between the vias may have a matrix structure having rows and columns within a range of from about 100 μm to about 500 μm, and may be within a range of from about 1500 μm to about 450 μm. If the distance between the vias is smaller than 100 μm, the number of the vias increases, and a light emitting area thereof is relatively reduced, and thus light emitting efficiency is reduced. If the distance between the vias is greater than 500 μm, current diffusion is difficult and thus light emitting efficiency may be reduced. Depths of the conductive vias may vary according to thicknesses of the second conductive semiconductor layer and the active layer, and may be, for example, within a range of about 0.5 μm and about 5.0 μm.

The first conductive semiconductor layer may be a nitride semiconductor layer satisfying N type AlxInyGa1-x-yN (0≦x<1, 0≦y<1, 0≦x+y<1). An N type impurity may be silicon (Si). For example, the first conductive semiconductor layer may be N type gallium nitride (GaN). The active layer use a multiple quantum well (MQW) in which a quantum well layer and a quantum barrier layer are alternately stacked, for example, a GaN/indium gallium nitride (InGaN) structure in the nitride semiconductor. The active layer may also be a single quantum well (SQW). The second conductive semiconductor layer may be a nitride semiconductor layer satisfying P type AlxInyGa1-x-yN (0≦x<1, 0≦y<1, 0≦x+y<1). A P type impurity may be magnesium (Mg). For example, the second conductive semiconductor layer may be P type AlGaN/GaN.

A first electrode may be disposed on the first conductive semiconductor layer. An ohmic contact layer and a second electrode may be sequentially arranged on the second conductive semiconductor layer. For example, the ohmic contact layer may include at least one selected from the group consisting of indium tin oxide (ITO), zinc oxide (ZnO), a graphene layer, and materials such as silver (Ag), nickel (Ni), Al, rhodium (Rh), palladium (Pd), iridium (Ir), ruthenium (Ru), Mg, zinc (Zn), platinum (Pt), gold (Au), etc., and may employ a two or more layer structure such as Ni/Ag, Zn/Ag, Ni/Al, Zn/Al, Pd/Ag, Pd/Al, Ir/Ag, Ir/Au, Pt/Ag, Pt/Al, Ni/Ag/Pt. The first and second electrodes are not limited thereto, may include materials such as Ag, Ni, Al, Rh, Pd, Ir, Ru, Mg, Zn, Pt, Au, etc., and may employ a single layer structure or a two or more layer structure. The first and second electrodes may be implemented as a flipchip structure by employing a reflective electrode structure, by way of example. For example, the first electrode may have a structure including a Al/titanium (Ti)/Pt/Ti layer (for example, an Al/Ti/Pt/Ti/chromium (Cr)/Au/tin (Sn) solder, an Al/Ti/Pt/Ti/Pt/Ti/Pt/Ti/Ni/Pt/Au/Sn solder, or an Al/Ti/Pt/Ti/Pt/Ti/Pt/Ti/Au/Ti/AuSn solder) or a structure including a Cr/Au layer (for example, Cr/Au/Pt/Ti/Ti/TiN/Ti/Ni/Au). The second electrode may have a structure including an Ag layer (for example, Ag/Ti/Pt/Ti/TiN/Ti/TiN/Cr/Au/Ti/Au).

The at least one LED device 220 may emit light by using a principle of generating light energy as much as an energy gap generated by holes of the P type semiconductor and electrons of the N type semiconductor. The at least one LED device 220 may be at least one blue LED and may generate white light having two or more peak wavelengths generated by combining yellow, green, or red phosphors, however it is understood that one or more other exemplary embodiments are not limited thereto. For example, according to another exemplary embodiment, the at least one LED device 220 may include a combination of different LEDs, e.g., a combination of green and red LEDs, a combination of green, red, and blue LEDs, etc. The white light may be disposed on a coordinate (x,y) line of a CIE 1931 coordinate system connecting the coordinates (0.4476, 0.4074), (0.3484, 0.3516), (0.3101, 0.3162), (0.3128, 0.3292), and (0.3333, 0.3333) or in a region surrounded by the line and a black body radiation spectrum. A color temperature of the white light may have a value corresponding to a range of about 2000K and about 20,000K.

Each of the at least one LED device 220 according to the present exemplary embodiment may further include a wavelength conversion unit (e.g., wavelength converter).

The wavelength conversion unit may include at least one of a resin layer, a glass layer, and a ceramic layer that contains a wavelength conversion material such as a phosphor or a quantum point. Thus, the wavelength conversion unit may be transparent or semitransparent. For example, when the wavelength conversion unit includes the resin layer containing the yellow phosphor, the wavelength conversion unit may be provided as a yellow semitransparent layer.

The wavelength conversion unit may be excited by light emitted from the at least one LED device 220 and may convert at least a part of the light to light of a different wavelength. The wavelength conversion material may be a material of two or more kinds providing light of different wavelengths. The white light may be output by mixing the light converted by the wavelength conversion unit and light that is not converted (see FIG. 12 for a detailed example of the phosphor).

As an example, the light generated by the at least one LED device 220 is blue light, and the wavelength conversion material P may include at least one phosphor selected from the group consisting of the green phosphor, the yellow phosphor, a golden yellow phosphor, and the red phosphor.

The at least one LED device 220 may be mounted on the substrate 210 by using at least one of methods selected from the group consisting of wire bonding, eutectic bonding, die bonding, and a surface mounting technology (SMT).

The LED module lens plate 100 is formed to cover a top surface of the LED module 200. The hinge structure 130 of the LED module lens plate is coupled to the fastening protrusion unit 234 of the heat dissipation member 230. In more detail, when the connection unit 134 of the hinge structure 130 is folded in a direction of an arrow illustrated in FIG. 5, the hinge body 1332 contacts a side surface of the heat dissipation member 230, and simultaneously, the fastening protrusion unit 234 of the heat dissipation member 230 is inserted into the fastening hole 132H of the hinge structure 130 so that the fastening protrusion unit 234 and the fastening hole 132H are integrally coupled to each other. When the fastening protrusion unit 234 and the fastening hole 132H are integrally coupled to each other, the LED module lens plate 100 is mounted on the LED module 200 so that an LED module lighting apparatus 1000 including the LED module lens plate 100 and the LED module 200 may be formed.

The LED module lens plate 100 and the LED module lighting apparatus 1000 according to an exemplary embodiment commonly include a lens plate including the hinge structure 130. As described above with reference to FIG. 1, the hinge structure 130 may be formed of an elastic material and may be folded, and thus the LED module lens plate 100 may be coupled to the LED module 200 and then separated therefrom. That is, the LED module lens plate 100 may be coupled to and separated from the LED module 200. A method of directly attaching the lens plate 110 onto the LED module 200 by using a screw or a method of directly bonding the lens plate 110 to the LED module 200 by using an adhesive agent may damage the lens substrate 110. The LED module lens plate 100 uses the elastic hinge structure 130, which prevents the above-described loss, thereby reducing time and cost spent in processing. The waterproof sealant 240 is formed on the top surface of the heat dissipation member 230, thereby improving a waterproof effect of the LED module 200.

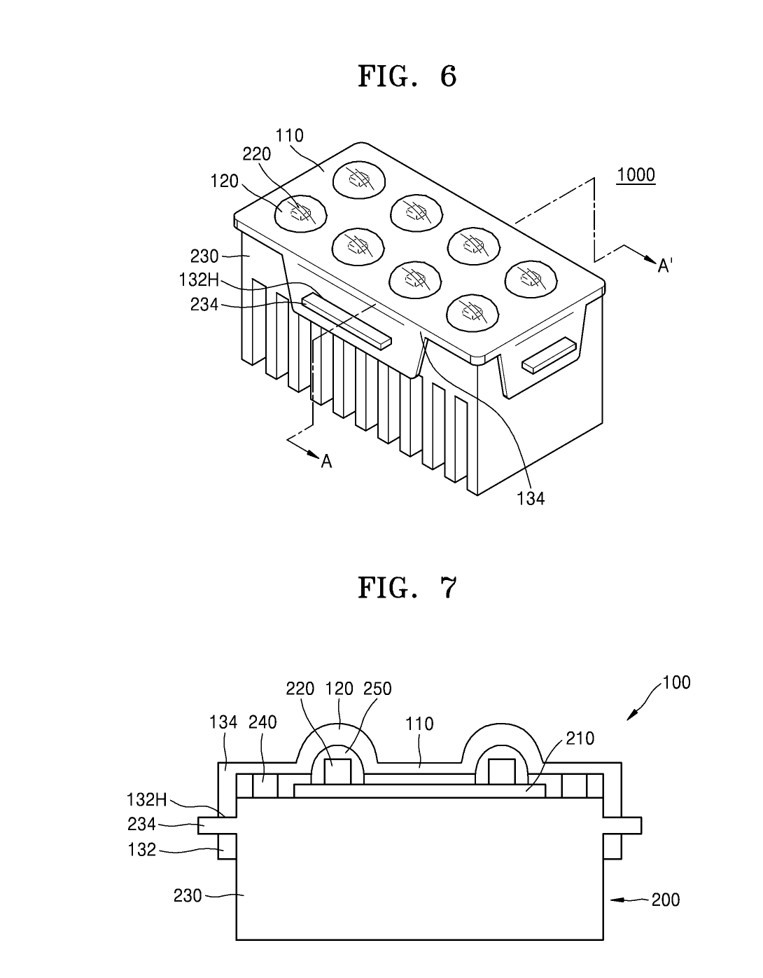

FIG. 6 is a perspective view of the LED module lighting apparatus 1000 according to an exemplary embodiment.

The LED module lighting apparatus 1000 may be formed by mounting the LED module lens plate 100 of FIG. 5 on the LED module 200 and integrally coupling the LED module lens plate 100 and the LED module 200. As described above with reference to FIG. 5, the hinge body 132 of the LED module lens plate 100 contacts and is connected to each side of the heat dissipation member 230, and the fastening protrusion unit 234 of the heat dissipation member 230 is inserted into and is integrally coupled to the fastening hole 132H. The at least one LED device 220 mounted on the substrate 210 of the LED module 200 may be disposed in a center portion of the lens unit 120 having a dome structure of the LED module lens plate 100. A protection film unit 250 (e.g., protection film) (see FIG. 7) may be formed (e.g., provided) between the lens unit 120 and the LED device 220. A detailed description of the protection film unit 250 will be provided below with reference to FIG. 7.

FIG. 7 is a cross-sectional view of a line A-A′ of the LED module lighting apparatus 1000 of FIG. 6.

Referring to FIG. 7, the substrate 210 is formed (e.g., provided) on a top surface of the heat dissipation member 230, the at least one LED device 220 is mounted on the substrate 210, and the LED module lens plate 100 is formed to cover the substrate 210 and the at least one LED device 220. The protection film unit 250 is formed between a bottom surface of a dome structure of the lens unit 120 of the LED module lens plate 100 and a top surface of each of the at least one LED device 220. The waterproof sealant 240 is formed between a top surface of the heat dissipation member 230 and the lens substrate 110 of the LED module lens plate 100.

The waterproof sealant 240 is formed to surround a top surface of the lens substrate 110 along an edge of each side of the lens substrate 110. A top surface of the waterproof sealant 240 is formed to contact a bottom surface of the lens substrate 110. The waterproof sealant 240 may be formed of (e.g., include) a waterproof material, for example, at least one selected from the group consisting of a liquid silicon sealant, a modified silicon sealant, a polyurethane sealant, and an SBR based sealant.

The protection film unit 250 is formed to cover the top surfaces of the at least one LED device 220. The protection film unit 250 may be an insulating film such as a passivation layer. For example, the protection film unit 250 may be formed of (e.g., include) various materials such as resin, glass, oxide, nitride, and ceramics. Although the protection film unit 250 employed in the present exemplary embodiment is an example of the insulating film such as the passivation layer, the protection film unit 250 may be a wavelength conversion unit (e.g., wavelength converter) containing a wavelength conversion material, such as a phosphor or a quantum point. A semiconductor light emitting device that emits white light may be provided by using the wavelength conversion unit. According to another exemplary embodiment, the at least one LED device 220 may include active layers having light of different wavelengths, thereby outputting the white light without using the phosphor.

The fastening protrusion unit 234 of the heat dissipation member 230 is inserted into and is integrally coupled to the fastening hole 132H of the hinge structure 130 formed on each side of the lens substrate 110. One side surface of the hinge body 132 facing the heat dissipation member 230 may directly or indirectly contact a side surface of the heat dissipation member 230 and is fixed to the side surface of the heat dissipation member 230. The hinge structure 130 is coupled to the heat dissipation member 230, and thus the LED module lens plate 100 may be coupled to the LED module 200. A top surface of the protection film unit 250 is formed to contact the bottom surface of the lens unit 120 so as to correspond to a position of the lens unit 120 of the LED module lens plate 100.

The hinge structure 130 may be coupled to the heat dissipation member 230 and then separated therefrom. As described with reference to FIG. 1, the hinge body 132 may be connected to the connection unit 134 that is elastic so that the hinge body 132 may be separated from the fastening protrusion unit 234. As described above, when the hinge structure 130 is separated from the heat dissipation member 230, the LED module lens plate 100 may be wholly separated. The LED module lens plate 100 may be separable from the LED module 200, and thus various lens plates may be advantageously mounted on or separated from the LED module 200 according to a light view angle or a light concentration degree. Various lens plates may be mounted on or separated from one LED module 200 during a manufacturing stage, thereby reducing the time and effort spent on manufacturing and test processes.

FIG. 8 is a perspective view of an LED module lighting apparatus 1100 according to another exemplary embodiment.

The LED module lighting apparatus 1100 may be formed by mounting the LED module lens plate 102 of FIG. 2 on the LED module 200 and integrally coupling the LED module lens plate 102 and the LED module 200. In the LED module lens plate 102, unlike the LED module lens plate 100 of FIG. 1, the hinge body 132 does not include the fastening hole 132H (see FIG. 1). However, the LED module lens plate 102 is integrally coupled to the heat dissipation member 230 via the fastening protrusion unit 136 (see FIGS. 2 and 9) formed on an inner side surface of the hinge body 132, of which a detailed description will be provided below with reference to FIG. 9.

FIG. 9 is a cross-sectional view of a line B-B′ of the LED module lighting apparatus 1100 of FIG. 8.

Referring to FIG. 9, the substrate 210 is formed on a top surface of the heat dissipation member 230, the at least one LED device 220 is mounted on the substrate 210, and the LED module lens plate 102 is formed to cover the substrate 210 and the LED devices 220. The protection film unit 250 is formed between the LED devices 220 and the LED module lens plate 102. A sealant (e.g., waterproof sealant 240) may be formed in an edge of the lens substrate 110. The LED module lens plate 102, the substrate 210, the LED devices 220, the waterproof sealant 240, and the protection film unit 250 are the same as or similar to those shown in FIG. 7, and thus redundant descriptions thereof are omitted below.

In the present exemplary embodiment, the fastening hole 132H is not formed in the hinge body 132A, and the fastening protrusion unit 136 protrudes from an inner side surface of the hinge body 132A instead. The fastening protrusion unit 136 protrudes at a predetermined height of the inner side surface of the hinge body 132A in a direction perpendicular to the inner side surface of the hinge body 132A. A protruding height and width of the fastening protrusion unit 136 are the same as or similar to a shape and a size of the fastening groove 236 of the heat dissipation member 230 that is extends in a direction toward the inside of the heat dissipation member 230. The fastening protrusion unit 136 may have a shape that protrudes at the predetermined height in the direction perpendicular to the inner side surface of the hinge body 132A as shown in FIG. 9, although it is understood that one or more other exemplary embodiments are not limited thereto. A shape of the fastening protrusion unit 136 may be L shaped, a hook, etc. When the connection unit 134 is elastic, the hinge body 132A contacts a sidewall of the heat dissipation member 230, and the fastening protrusion unit 136 is inserted into the fastening groove 236, and thus the LED module lens plate 102 according to the present exemplary embodiment may be integrally coupled to the LED module 200. Owing to the elasticity of the connection unit 134, the hinge structure 130 is separable from the heat dissipation member 230, and thus the LED module lens plate 102 may be wholly separated. An effect of separating the LED module lens plate 102 is the same as described with reference to FIG. 7, and thus a redundant description thereof will be omitted below.

FIG. 10 is a perspective view of an LED module lighting apparatus 1200 according to another exemplary embodiment.

Referring to FIG. 10, the LED module lens plate 104, the substrate 210, the at least one LED device 220, the waterproof sealant 240, and the protection film unit 250 are the same as or similar to those of the LED module lighting apparatuses 1000 and 1100 of FIGS. 6 and 8, respectively. However, the LED module lighting apparatus 1200 according to the present exemplary embodiment is different from the LED module lighting apparatuses 1000 and 1100 in terms of a structure of the hinge structure 130B. Redundant descriptions of the LED module lens plate 104, the substrate 210, the at least one LED device 220, the waterproof sealant 240, and the protection film unit 250 will be omitted here.

The fastening screw hole 138H is formed in the hinge body 132B. The fastening screw 138 is inserted into the fastening screw hole 138H. The fastening screw hole 138H may be formed as a circular hole, although it is understood that one or more other exemplary embodiments are not limited thereto. That is, the fastening screw hole 138H may have various shapes. The fastening screw 138 may be inserted from the outside of the hinge body 132B in a direction perpendicular to a top surface of the hinge body 1332B and may be integrally coupled to the LED module 200 (see FIG. 11). This will be described in detail with reference to FIG. 11 below.

Referring to FIG. 11, when the connection unit 134 of a hinge structure folds, the hinge body 132B directly or indirectly contacts a side wall of the heat dissipation member 230, and the fastening screw hole 138H is inserted into the fastening screw hole 138H that has a circular shape formed in the hinge body 132B and is fastened to a heat dissipation member screw hole 238H through the fastening screw hole 138H. The fastening screw 138 may be inserted in a direction perpendicular to the inner surface of the hinge body 132B.

When the fastening screw 138 is fastened to the heat dissipation member screw hole 238H through the hinge body 132B, the LED module lens plate 104 is connected to the LED module 200 to form the LED module lighting apparatus 1200. The fastening screw 138 is inserted into the hinge body 132B, thereby preventing loss due to damage to the lens substrate 110 during the manufacturing processing that occurs when the fastening screw 138 is directly inserted into the lens substrate 110 of the LED module lens plate 104.

The at least one LED device 220 (see FIG. 5) included in various exemplary embodiments may be at least one LED that emits blue light. A wavelength conversion unit (e.g., wavelength converter) described as an example of a protection layer may convert a part of the blue light into at least one selected from the group consisting of yellow light, green light, red light, and orange light and mix the blue light that is not converted and the converted light, thereby emitting white light.

According to another exemplary embodiment, when the at least one LED device 220 (see FIG. 5) emits infrared rays, the wavelength conversion unit may include phosphors that emit blue light, green light, and red light. In this case, the LED device 220 including the wavelength conversion unit may adjust a color rendering index (CRI) from a sodium (Na) lamp (of 40) to a solar light lamp (of 100). The LED device 220 also may generate various white light having a color temperature from about 2000K to about 20,000K, and generate violet, blue, green, and orange invisible light or infrared rays according to, for example, necessity to adjust a lighting color in accordance with a peripheral atmosphere or a mood. The LED device 200 also may generate a special wavelength of light that may promote plant growth.

White light generated by combining a blue LED chip and yellow, green, and red phosphors and/or green and red LED devices may have two or more peak wavelengths, and may be disposed on a coordinate (x,y) line of a CIE 1931 coordinate system connecting the coordinates (0.4476, 0.4074), (0.3484, 0.3516), (0.3101, 0.3162), (0.3128, 0.3292), and (0.3333, 0.3333) or in a region surrounded by the line and a black body radiation spectrum. A color temperature of the white light may correspond to a range of from about 2000K to about 20,000K.

Hereinafter, a phosphor that may be employed in a wavelength conversion unit that is an example of a protection layer will be described in detail with reference to FIG. 12

The phosphor may have the following formulas and colors.

Oxide: yellow and green Y3Al5O12:Ce, Tb3Al5O12:Ce, Lu3Al5O12:Ce

Silicate: yellow and green (Ba,Sr)2SiO4:Eu, and yellow and orange (Ba,Sr)3SiO5:Ce

Nitride: green β-SiAlON:Eu, yellow L3Si6O11:Ce, orange α-SiAlON:Eu, and red CaAlSiN3:Eu, Sr2Si5N8:Eu, SrSiAl4N7:Eu

Fluoride: KSF red K2SiF6:Mn4+

The formulas of the phosphor may basically satisfy stoichiometry, and each element thereof may be replaced with another element of each group of the periodic table. For example, strontium (Sr) may be replaced with barium (Ba), calcium (Ca), Mg, etc., of Group II alkaline earths, and yttrium (Y) may be replaced with lanthanum series terbium (Tb), lutetium (Lu), scandium (Sc), gadolinium (Gd), etc. An activator europium (Eu) may be replaced with cerium (Ce), Tb, praseodymium (Pr), erbium (Er), ytterbium (Yb), etc., according to, for example, a desired energy level. The activator solely or a sub activator for modification of a characteristic may be additionally applied.

Materials such as a quantum dot (QD) may be applied as a phosphor substance material. An LED may be used in combination of the phosphor and the QD or solely.

The QD may be configured as a structure of a core (3 nm˜10 nm) such as CdSe, InP, etc. and a shell (0.5 nm˜2 nm) such as ZnS, ZnSe, etc., and a ligand for stabilization of the core and the shell, and may implement various colors according to its size.

Table 1 below shows types of phosphors according to application fields of a white LED device that uses an LED (440 nm˜460 nm).

TABLE 1

| Use | Phosphors |
|---|---|
| LED TV BLU | β-SiAlON:Eu2+ |
| | (Ca, Sr)AlSiN3:Eu2+ |
| | L3Si6O11:Ce3+ |
| | K2SiF6:Mn4+ |
| Lighting | Lu3Al5O12:Ce3+ |
| | Ca-α-SiAlON:Eu2+ |
| | L3Si6N11:Ce3+ |
| | (Ca, Sr)AlSiN3:Eu2+ |
| | Y3Al5O12:Ce3+ |
| | K2SiF6:Mn4+ |
| Side View | Lu3Al5O12:Ce3+ |
| (Mobile, Note PC) | Ca-α-SiAlON:Eu2+ |
| | L3Si6N11:Ce3+ |
| | (Ca, Sr)AlSiN3:Eu2+ |
| | Y3Al5O12:Ce3+ |
| | (Sr, Ba, Ca, Mg)2SiO4:Eu2+ |
| | K2SiF6:Mn4+ |
| Overall Length | Lu3Al5O12:Ce3+ |
| (Head Lamp, etc.) | Ca-α-SiAlON:Eu2+ |
| | L3Si6N11:Ce3+ |
| | (Ca, Sr)AlSiN3:Eu2+ |
| | Y3Al5O12:Ce3+ |
| | K2SiF6:Mn4+ |

A method of coating the phosphors or the QD may use at least one of a method of spraying the phosphors or the QD onto an LED device, a method of applying the phosphors or the QD as a layer shape, and a method of attaching the phosphors or the QD as a sheet shape such as a film or a ceramic phosphor, etc.

The spray method includes generally dispensing, spray coating, etc. Dispensing includes a pneumatic method and a mechanical method such as a screw, a linear type, etc. A jetting method can be used to control a coating amount by spraying a small amount of phosphors and to control a color coordinate by controlling the coating amount. A method of coating the phosphors on a wafer level or the LED device by spraying may facilitate productivity and control thickness.

A method of directly covering the phosphors QD on the LED device in a layer shape may be applied as electrophoresis, screen printing, or molding of phosphors. The corresponding method may be different according to whether coating of sides of a chip is necessary.

To control efficiency of a long wavelength LED phosphor that re-absorbs light that is emitted in a short wavelength among two or more different types of phosphors, two or more types of phosphor layers having different wavelengths may be classified. To minimize wavelength re-absorption and interference of a chip and two or more types of phosphors, a DBR (ODR) layer between layers may be included. To form a uniform coating layer, a phosphor may be attached onto a chip after being produced as a film or to have a ceramic film.

To differentiate light efficiency and a light distribution characteristic, a light conversion material may be disposed in a remote manner. The light conversion material may be disposed with a material such as transmittance polymer, glass, etc., according to durability and heat resistance

The QD may be disposed on the LED device in the same manner as with the phosphors, and interposed between materials such as glass or transmittance polymer to perform light conversion.

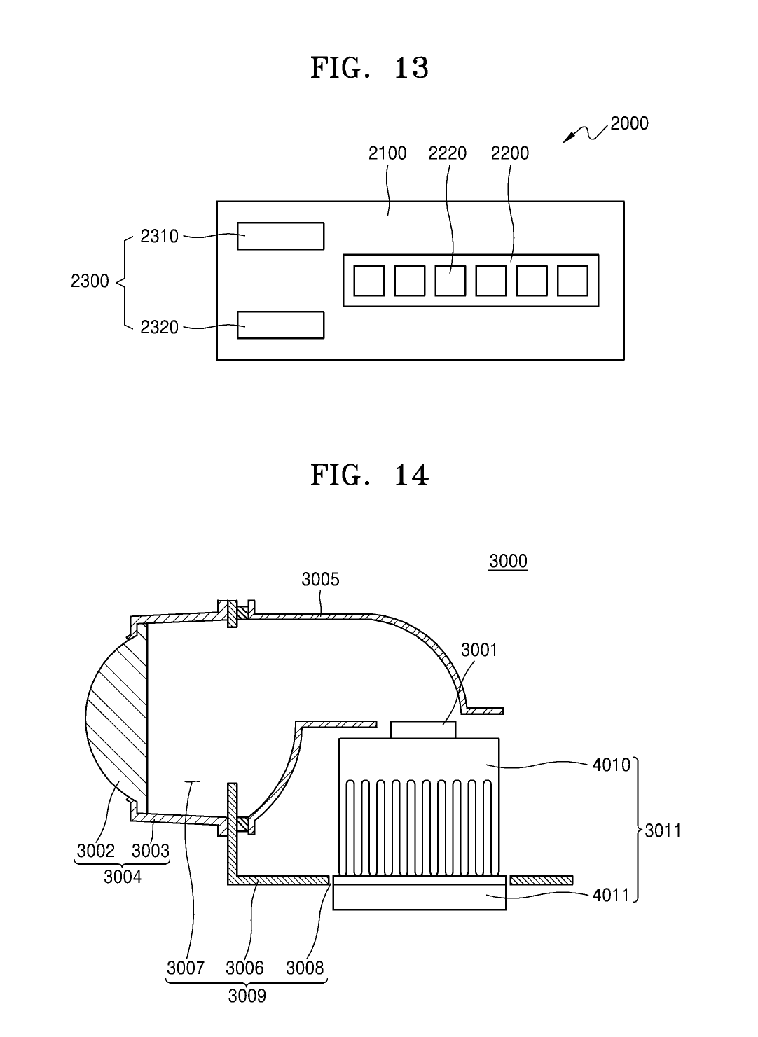

FIG. 13 is a conceptual diagram of an LED module lighting apparatus system 2000 according to another exemplary embodiment.

Referring to FIG. 13, the LED module lighting apparatus system 2000 includes an LED module 2200 and a power supply unit 2300 (e.g., power supplier) disposed on a structure 2100. The LED module lens plates 100, 102, and 104 described with reference to FIGS. 1 through 3 above may be formed to cover all of the structure 2100, the LED module 2200, and the power supply unit 2300.

The LED module 2200 includes a plurality of LEDs 2220. The LED module 2200 may be the LED module 200 described above with reference to FIGS. 5 through 11. The LED devices 2220 may be the LED devices 220 described above with reference to FIGS. 5 through 11.

The power supply unit 2300 includes an interface 2310 that receives power and a power control unit 2320 (e.g., power controller) that controls power supplied to the LED module 2200. The interface 2310 may include a fuse that protects against overcurrent and an electromagnetic wave shield filter that shields an electromagnetic interference signal. The power control unit 2320 may include a rectification unit (e.g., rectifier) that converts alternating current (AC) when the AC is input as power into direct current (DC), a planarization unit (e.g., planarizer), and a constant voltage control unit (e.g., constant voltage controller) that converts a voltage into a voltage suitable for the LED module 2200. The power supply unit 2300 may include a feedback circuit apparatus that compares an emitting amount of each of the LED devices 2220 with a preset emitting amount and a memory apparatus that stores information such as desired brightness, a CRI, etc.

The LED module lighting apparatus system 2000 may be used as a backlight for a display apparatus such as a liquid crystal display (LCD) apparatus including an image panel, a lamp, an indoor lighting lamp such as flat panel lighting, an outdoor lighting apparatus such as a sign, etc. Alternatively, the LED lighting apparatus system 2000 may be used in a lighting apparatus for various transportation devices, such as a car, a ship, or an airplane, a home appliance such as a TV, a refrigerator, etc., or a medical device.

FIG. 14 is a diagram of an example of an LED device applied to a head lamp 3000 according to an exemplary embodiment.

Referring to FIG. 14, the head lamp 3000 used as a vehicle light includes a light source 3001, a reflection unit 3005 (e.g., reflector), and a lens cover unit 3004 (e.g., lens cover). The lens cover unit 3004 may include a hollow type guide 3003 and a lens 3002. The light source 3001 may include the LED device 220 (see FIG. 5) described above or the LED module 200 (see FIGS. 5 through 11).

The head lamp 3000 may further include a heat dissipation unit 3011 (e.g., heat dissipater) that dissipates light generated by the light source 3001 to the outside. The heat dissipation unit 3012 may include a heat sink 4010 and a cooling fan 4011 to effectively dissipate heat. The head lamp 3000 may further include a housing 3009 that fixes and supports the heat dissipation unit 3011 and the reflection unit 3005. The housing 3009 may include a body unit 3006 (e.g., body) and a center hole 3008 having a first surface to which the heat dissipation unit 3012 is coupled and installed.

The housing 3009 may include a front hole 3007 in another surface connected to the first surface and curved in a rectilinear direction to allow the reflection unit 3005 to be disposed on a top side of the light source 3001. Accordingly, the front side is opened by the reflection unit 3005, and the reflection unit 3005 is fixed to the housing 3009 so that the open front side corresponds to the front hole 3007, and thus light reflected through the reflection unit 3005 may be emitted to the outside through the front hole 3007.

As described above, a hinge structure 130, 130A, and 130B may have different configurations or structures in various exemplary embodiments. That is, a hinge structure 130, 130A, or 130B may include a fastening hole 132H, a fastening protrusion unit 136, or a fastening screw hole 138H. However, it is understood that one or more other exemplary embodiments are not limited to the aforementioned fastening structures. For example, according to another exemplary embodiment, a hinge structure may include a combination of different fastening structures, e.g., a combination of a fastening hole and a fastening protrusion unit, a combination of a fastening hole, a fastening protrusion unit, and a fastening screw hole, etc. Furthermore, according to another exemplary embodiment, the hinge structure may include a plurality of fastening structures, e.g., a plurality of fastening holes, a plurality of fastening protrusion units, etc. Furthermore, according to another exemplary embodiment, different hinge structures of a same LED module lens plate may include different fastening structures.

While exemplary embodiments have been particularly shown and described above, it will be understood that various changes in form and details may be made therein without departing from the spirit and scope of the following claims.

What is claimed is:

1. A lens plate for a light emitting diode (LED) module, the lens plate comprising:
a lens substrate having a plane structure;
at least one lens having a dome structure on the lens substrate; and
a hinge structure on a side of the lens substrate and comprising a fastener configured to fasten with the LED module.

2. The lens plate for the LED module of claim 1, wherein the hinge structure is integrally formed with the lens substrate.

3. The lens plate for the LED module of claim 1, wherein the hinge structure comprises an elastic material and is foldable with respect to the lens substrate.

4. The lens plate for the LED module of claim 1, wherein the fastener is a fastening hole having a straight line shape in a direction parallel to a top surface of the lens substrate.

5. The lens plate for the LED module of claim 1, wherein the fastener is a fastening protrusion that protrudes from an inner surface of the hinge structure.

6. The lens plate for the LED module of claim 1, further comprising a plurality of hinge structures, including the hinge structure, on two opposite sides of the lens substrate.

7. An LED module lighting apparatus comprising:
a heat dissipation member configured to dissipate heat;
a substrate on a top surface of the heat dissipation member;
at least one LED device mounted on the substrate; and
a lens plate for an LED module, the lens plate configured to cover the heat dissipation member, the substrate, and a top surface of the at least one LED device,
wherein the lens plate comprises a hinge structure is on a side of the lens plate, the hinge structure comprising a first fastener configured to fasten with the heat dissipation member,
wherein the heat dissipation member comprises a second fastener on a side surface of the heat dissipation member, and
wherein the first fastener and the second fastener are coupled to each other so that the heat dissipation member and the lens plate for the LED module are connected.

8. The LED module lighting apparatus of claim 7, further comprising a sealant between the top surface of the heat dissipation member and a bottom surface of the lens plate for the LED module.

9. The LED module lighting apparatus of claim 8, wherein the sealant is along each side edge of the top surface of the heat dissipation member.

10. The LED module lighting apparatus of claim 7, wherein:
the second fastener protrudes to an outside of the heat dissipation member;
the first fastener is a fastening hole having a size corresponding to that of the second fastening unit; and
the hinge structure is connected to the second fastener through the fastening hole.

11. The LED module lighting apparatus of claim 7, wherein:
the second fastener is a fastening groove having a predetermined size;
the hinge structure further comprises a hinge body;
the first fastener is a fastening protrusion protruding in a perpendicular direction with respect to an inner side surface of the hinge body;
the fastening protrusion has a size corresponding to that of the fastening groove; and
the fastening protrusion is inserted into the fastening groove so that the hinge structure is coupled to the heat dissipation member.

12. The LED module lighting apparatus of claim 7, wherein:
the lens plate further comprises a plurality of hinge structures, including the hinge structure, on two opposite sides of the lens plate;
wherein the heat dissipation member further comprises a third fastener;
wherein the second fastener and the third fastener are on opposite sides of the heat dissipation member corresponding to the two opposite sides in which the hinge structures; and
wherein the plurality of hinge structures and the second and third fasteners are coupled to each other.

13. The LED module lighting apparatus of claim 7, wherein the hinge structure is elastic so that the hinge structure is unfoldable to be parallel to a top surface of the lens plate of the LED module, and is foldable in a direction toward the heat dissipation member.

14. The LED module lighting apparatus of claim 7, wherein:
wherein the first fastener is separable from the second fastener after being coupled thereto, and
wherein the lens plate is detachable from the heat dissipation member when the first fastener is separated from the second fastener.

15. The LED module lighting apparatus of claim 7, wherein:
the first fastener is at least one lens plate screw hole formed in the hinge structure;
the second fastener is at least one heat dissipation member screw hole corresponding to the at least one lens plate screw hole formed in the heat dissipation member;
at least one fastening screw is inserted into the at least one lens plate screw hole; and
the at least one fastening screw is fastened to the at least one heat dissipation member screw hole so that the lens plate for the LED module and the heat dissipation member are coupled to each other.

16. An LED module lighting apparatus comprising:
an LED module comprising at least one LED device; and
a lens plate configured to cover the at least one LED device,
wherein the lens plate comprises:
a lens substrate having a plane structure,
at least one lens on the lens substrate, and
a hinge structure on a side of the lens substrate and comprising a fastener configured to fasten with the LED module.

17. The LED module lighting apparatus of claim 16, wherein the hinge structure is integrally formed with the lens substrate and is foldable with respect to the lens substrate.

18. The LED module lighting apparatus of claim 16, wherein the fastener is a fastening hole having a straight line shape in a direction parallel to a top surface of the lens substrate.

19. The LED module lighting apparatus of claim 16, wherein the fastener is a fastening protrusion that protrudes from an inner surface of the hinge structure.

20. The LED module lighting apparatus of claim 16, wherein the fastener is at least one lens plate screw hole formed in the hinge structure.
